(19) United States
(12) Patent Application Publication
(10) Pub. No.: US 2024/0280476 A1
(43) Pub. Date: Aug. 22, 2024

(54) ANALYSIS METHOD AND ANALYSIS DEVICE

(71) Applicant: HITACHI HIGH-TECH CORPORATION, Tokyo (JP)

(72) Inventors: Megumi MIZUNO, Tokyo (JP); Naomi ISHII, Tokyo (JP); Sakiko NARIKAWA, Tokyo (JP)

(21) Appl. No.: 18/571,281

(22) PCT Filed: Jul. 20, 2021
(86) PCT No.: PCT/JP2021/027205

§ 371 Date: Dec. 18, 2023

(51) Int. Cl. G01N 21/31; G01N 21/25

(52) U.S. Cl. CPC G01N 21/31; G01N 21/255

(57) ABSTRACT

The analysis device is provided with multiple reference samples which differ in transmittance and color, a storage unit which stores the brightness values, and a control value of the light source. The control unit irradiates the reference sample with light at a set control value, and stores an acquired measured brightness value of the reference sample, and an adjustment control value of the light source for adjusting to a set reference brightness value; from the brightness value of a sample to be measured, which was acquired by irradiating the sample to be measured with light on the basis of the control value, the control unit calculates an adjustment control value of the light source on the basis of the relation between the adjustment control value of the light source and the brightness value of the sample to be measured, and uses the adjustment control value to irradiate light.

### TECHNICAL FIELD

The present invention relates to an analysis method and an analysis device that perform measurement while correcting a light quantity for each sample.

### BACKGROUND ART

An analysis device that irradiates a sample with light and acquires a measured value irradiates the sample with a constant light quantity from a light source, and acquires transmitted light, reflected light, or light emitted from the sample by a light receiving element. Then, the properties, concentration, shape, and the like of the sample are quantitatively measured from a quantity of received light acquired by the light receiving element. When factors other than the sample, such as the presence of impurities contained in the sample, influence the quantity of received light, this causes a decrease in measurement accuracy.

For example, PTL 1 mentions a decrease in detection sensitivity due to changes in components of an optical system with lapse of time and instrumental errors between devices.

PTL 1 addresses problems to be solved such as a decrease in detection sensitivity due to changes in components of the optical system with lapse of time and instrumental errors between devices in a nucleic acid analysis device that measures changes in fluorescence intensity with lapse of time. As a solution to the problems, an analysis device that uses a reference sample having a constant concentration and containing a fluorescent dye to adjust a current value of the light source so that the fluorescent light quantity emitted by the reference sample becomes a reference value, is described.

### CITATION LIST

### Patent Literature

PTL 1: JP2011-007642A

### SUMMARY OF INVENTION

### Technical Problem

By the way, when impurities are mixed in a sample to be measured, the hue and concentration of the impurities influence a quantity of received light and cause a decrease in measurement accuracy. For example, in an analysis device that measures bacterial growth using a biological sample solution such as blood, impurities such as hemoglobin and bilirubin, which are blood components, can also be factors, and thus the quantity of received light decreases.

When imaging the biological sample solution with a camera, light transmittance varies for each sample due to the factor of impurities, which results in occurrence of a difference in the obtained brightness. With this, analysis accuracy is reduced in image analysis.

In the technique described in PTL 1, a light source is adjusted so that the quantity of received light becomes a reference value with respect to the reference sample.

However, since the light source is not adjusted for each sample, the reduction in light transmittance that occurs for each sample is not taken into consideration.

In order to solve these problems, in methods in the related art, it is necessary (there are methods) to remove impurities from the sample in advance, such as by a method of detecting only the target substance by mixing a reagent such as a fluorescent reagent or a staining agent that specifically reacts with a substance to be measured with the sample in advance, a method of separating components by centrifugation, or a method of culturing bacteria and creating a bacterial solution from the formed colonies in bacterial tests.

However, such methods of adding reagents and removing impurities have problems such as increasing the cost of detection, complicating the work processes, and increasing the measurement time.

Further, it may not be possible to completely remove the influence of impurities.

In view of the problems described above, an object of the invention is to realize an analysis method and an analysis device that can exclude the influence of impurities during measurement and obtain an accurate brightness value of an object to be measured while suppressing increases in cost and complication of work processes.

### Solution to Problem

In order to achieve the object described above, the invention is configured as follows.

There is provided an analysis method of irradiating a sample with light and analyzing the sample by using a light source that irradiates the sample with light, an imaging unit that condenses transmitted light transmitting through the sample, receives a quantity of the condensed light, and acquires a brightness value, and a control unit that controls the light source and the imaging unit, the analysis method including: irradiating two or more reference samples that differ in at least one of transmittance or color with light from the light source using a preset control value; storing a measured brightness value of the reference sample acquired by the imaging unit and an adjustment control value of the light source for adjusting the measured brightness value of the reference sample to a preset reference brightness value in a storage unit; irradiating a sample to be measured with light from the light source using the preset control value; calculating the adjustment control value of the light source, based on a relationship between the adjustment control value of the light source stored in the storage unit and the brightness value of the sample to be measured, from a brightness value of the sample to be measured acquired by the imaging unit; and performing irradiation with light from the light source using the calculated adjustment control value and acquiring the brightness value of the sample to be measured by the imaging unit.

There is provided an analysis device that irradiates a sample with light, analyzes the sample, and includes a light source that irradiates the sample with light, an imaging unit that condenses transmitted light transmitting through the sample, receives a quantity of the condensed light, and acquires a brightness value, and a control unit that controls the light source and the imaging unit, the analysis device including: two or more reference samples that differ in at least one of transmittance or color; and a storage unit that stores the brightness value and a control value of the light source, in which the control unit causes the reference sample to be irradiated with light from the light source using a preset control value and causes the storage unit to store a measured brightness value of the reference sample acquired by the imaging unit and an adjustment control value of the light source for adjusting the measured brightness value of the reference sample to a preset reference brightness value, irradiates a sample to be measured with light from the light source using the preset control value and calculates the adjustment control value of the light source, based on a relationship between the adjustment control value of the light source stored in the storage unit and the brightness value of the sample to be measured, from a brightness value of the sample to be measured acquired by the imaging unit, and causes irradiation with light from the light source to be performed using the calculated adjustment control value and causes the imaging unit to acquire the brightness value of the sample to be measured.

### Advantageous Effects of Invention

It is possible to realize an analysis method and an analysis device that can remove the influence of impurities during measurement and obtain an accurate brightness value of an object to be measured, while suppressing increases in cost and complication of work processes.

### BRIEF DESCRIPTION OF DRAWINGS

FIG. 1 is a diagram illustrating a configuration of an analysis device that irradiates a sample with light and acquires a measured value in Embodiment 1.

FIG. 2 is a flowchart of acquiring a reference value for adjusting a quantity of irradiation light from a light source, which is performed by a control unit.

FIG. 3 is a flowchart of adjusting the quantity of irradiation light from the light source and measuring a sample to be measured, which are performed by the control unit.

FIG. 4A is a diagram illustrating a relationship between control values of the light source for a reference sample.

FIG. 4B is a diagram illustrating a relationship between the control values of the light source for the reference sample.

FIG. 5A is a diagram illustrating a relationship between control values of the light source for a sample.

FIG. 5B is a diagram illustrating a relationship between the control values of the light source for the sample.

FIG. 6 is a flowchart of measuring a reference sample in Embodiment 2.

FIG. 7 is a flowchart of measuring a sample to be measured in Embodiment 2.

### DESCRIPTION OF EMBODIMENTS

Hereinafter, embodiments of the invention will be described with reference to FIG. 9. Common members in respective drawings are given the same reference numerals.

### EMBODIMENTS

### Embodiment 1

Embodiment 1 describes an analysis method and an analysis device for correcting fluctuations in a quantity of received light caused by impurities for a sample in which impurities are mixed and performing measurement, in the analysis device that irradiates a sample with light and acquires a measured value. Impurities are components other than a substance to be measured, such as pigment components and components that react with reagents. Embodiments of pigment components in bacterial tests using blood culture samples include hemoglobin of a red pigment and bilirubin of a yellow pigment contained in blood.

FIG. 1 is a diagram illustrating a configuration of the analysis device that irradiates a sample with light and acquires a measured value in Embodiment 1.

In FIG. 1, an analysis device 100 is an analysis device that irradiates a sample with light and acquires a measured value. The analysis device 100 includes a light source 101, an objective lens 102, a camera 103, a storage unit 104, and a control unit 105. A sample 106 is stored in a sample container 107 and held in a sample holding unit 110. A reference sample 108 is stored in a reference sample container 109 and accommodated in an accommodation unit 111.

In the analysis device 100, one sample container 107 stores one sample 106, which is a sample to be measured, but one sample container 107 may store one or more samples.

The reference samples 108 are two or more samples that differ in at least one of light transmittance and color. One or more reference samples 108 may be stored in one reference sample container 109. Further, there may be one or more reference sample containers 109, and two or more reference samples 108 may be stored in a plurality of the reference sample containers 109.

The light source 101 is a mechanism that irradiates the sample 106 with light. The light source 101 is, for example, a light emitting diode or the like.

The objective lens 102 is a mechanism that condenses light emitted by the light source 101 onto the camera 103.

The camera 103 is a mechanism that receives light condensed by the objective lens 102 and measures a quantity of received light as a brightness value using an imaging element configured with a photodiode or the like.

The objective lens 102 and the camera 103 form an imaging unit, which is a mechanism that receives transmitted light transmitting through the sample 106, reflected light reflected by the sample 106, or emitted light from a fluorescent substance contained in the sample 106, measures the quantity of received light, and may be a one-dimensional optical sensor.

The control unit 105 includes a circuit board, software, and the like, and controls a quantity of irradiation light from the light source 101, the exposure time of the camera 103, and the like.

The storage unit 104 stores a brightness value acquired by the camera 103 and a control value obtained by controlling the quantity of irradiation light from the light source, the exposure time of the camera, and the like by the control unit 105. In the example illustrated in FIG. 1, the storage unit 104 is provided within the device, but the storage unit 104 may be coupled to an external system connected via a network, universal serial bus (USB), or the like.

The holding unit 110 is a mechanism that installs and fixes the sample 106. Further, the holding unit 110 is a mechanism and fixes the reference sample container 109. FIG. 1 illustrates a state in which the holding unit 110 installs and fixes the sample 106 stored in the sample container 107 and the sample 106 is irradiated with light from the light source 101, but the holding unit 110 can install and fix the reference sample 108 stored in the reference sample container 109 instead of the sample container 107 and the reference sample 108 can be irradiated with light from the light source 101.

The accommodation unit 111 is a mechanism that accommodates the reference sample container 109. The accommodation unit 111 may be located inside the analysis device 100 or may be configured independently outside the analysis device 100.

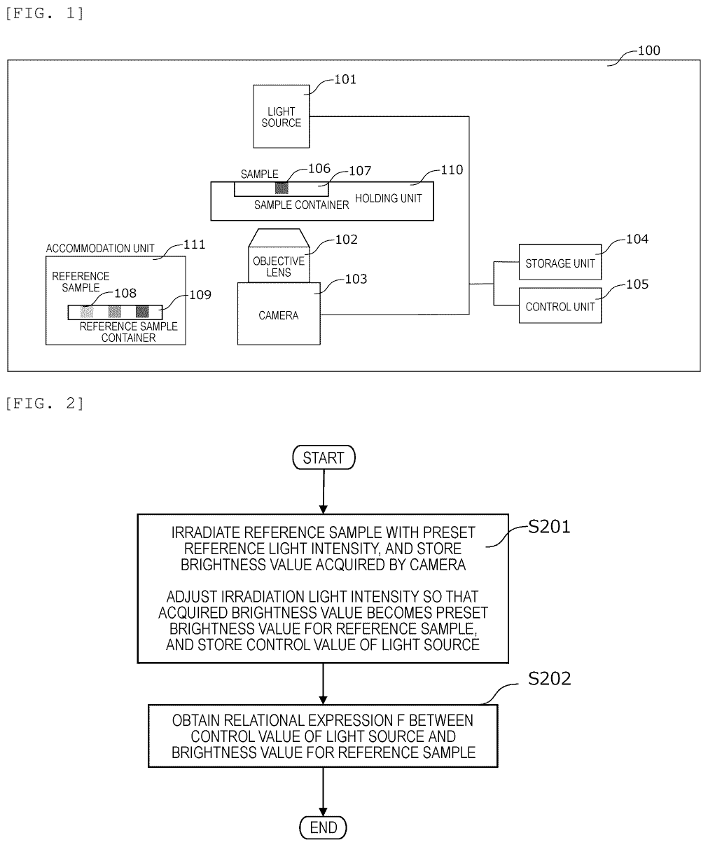

FIG. 2 is a flowchart of acquiring a reference value for adjusting the quantity of irradiation light from the light source 101, which is performed by the control unit 105.

In FIG. 2, in step S201, the reference sample 108 is measured. Two values are stored in the storage unit 104 for each of two or more reference samples 108.

One value is a brightness value (measured brightness value) acquired when the reference sample 108 is irradiated with a reference light quantity. The reference sample 108 is irradiated with the reference light quantity from the light source 101 using a preset control value. Then, the brightness value (measured brightness value) acquired by the camera 103 is stored in the storage unit 104. With this, a relationship between the light transmittance or color and the acquired brightness can be obtained.

Therefore, the light transmittance or color of the sample 106 can be estimated from the measured brightness value when performing irradiation with the reference light quantity.

The other one is a quantity of irradiation light that becomes a preset reference brightness value (the true brightness value of the reference sample). A control value of the light source 101 is corrected so that the measured brightness value acquired by the camera 103 becomes the reference brightness value, and is used as an adjustment control value. Then, the adjustment control value of the light source 101 is stored in the storage unit 104. With this, it is possible to obtain the control value of the light source 101 for correcting the difference in light transmittance or color for each sample 106 and obtaining the reference brightness value.

In step S202, a relational expression F between the control value of the light source 101 and the brightness value is obtained. From the values stored in step S201, the relational expression F of the adjustment control value for obtaining the reference brightness value is created for the brightness value measured using a preset control value of the light source 101. With this, the adjustment control value for obtaining the reference brightness for each sample can be obtained from the brightness value measured using the preset control value of the light source 101 (the adjustment control value of the light source 101 can be calculated from the relational expression F), and thus the adjustment time of the light source 101 can be shortened.

The relational expression F is a relational expression in which a set of numerical values of “brightness value measured using the preset control value of light source 101” and “control value of light source 101 (adjustment control value) that becomes the reference brightness value”, which are obtained by measuring and storing two or more reference samples in step S201, is approximated to a linear function, an n-dimensional function (n is an integer of 2 or more), a logarithmic curve, and the like by the least square method or the like.

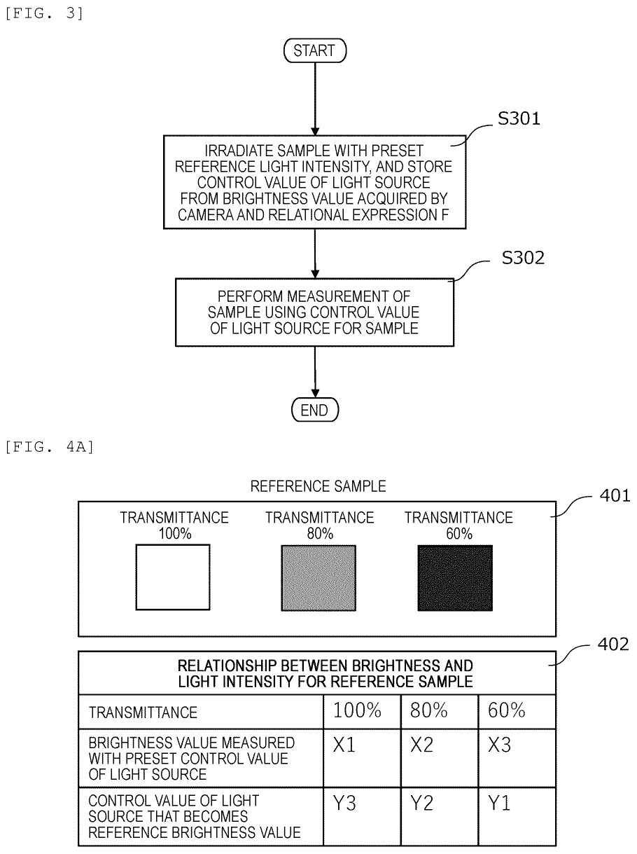

FIG. 3 is a flowchart of adjusting the quantity of irradiation light from the light source 101 and measuring the sample to be measured, which are performed by the control unit 105.

In FIG. 3, in step S301, the sample 106, which is the sample to be measured, is measured, and the light transmittance or color of impurities contained in the sample 106 is estimated. The sample 106 is irradiated with light from the light source 101 using the preset control value. Then, the measured brightness value acquired by the camera 103 is applied to the relational expression F obtained in step S202, and the control value of the light source 101 for each sample 106 is stored in the storage unit 104.

In step S302, the difference in light transmittance or color of impurities contained in the sample 106 is corrected, and the sample 106 is measured. The sample 106 is measured using the control value of the light source 101 stored in step S301.

FIGS. 4A and 4B are diagrams illustrating a relationship between the control values of the light source 101 for the reference sample.

FIG. 4A illustrates an example in which a reference sample 401 is a plurality of transmittance reference samples 108. A case where the transmittance reference samples 108 are two or more samples that differ in at least one of light transmittance or color, and samples having transmittances of 100%, 80%, and 60% are used is illustrated. When the control value of the light source 101 and brightness stored in step S201 correspond to a relationship 402 between brightness and light quantity for the reference sample, the relational expression F in step S202 becomes an expression 403 illustrated in FIG. 4B. In FIG. 4B, the vertical axis indicates the control value of the light source 101, which is a reference basic value, and the horizontal axis indicates the brightness value measured using the preset control value of the light source 101.

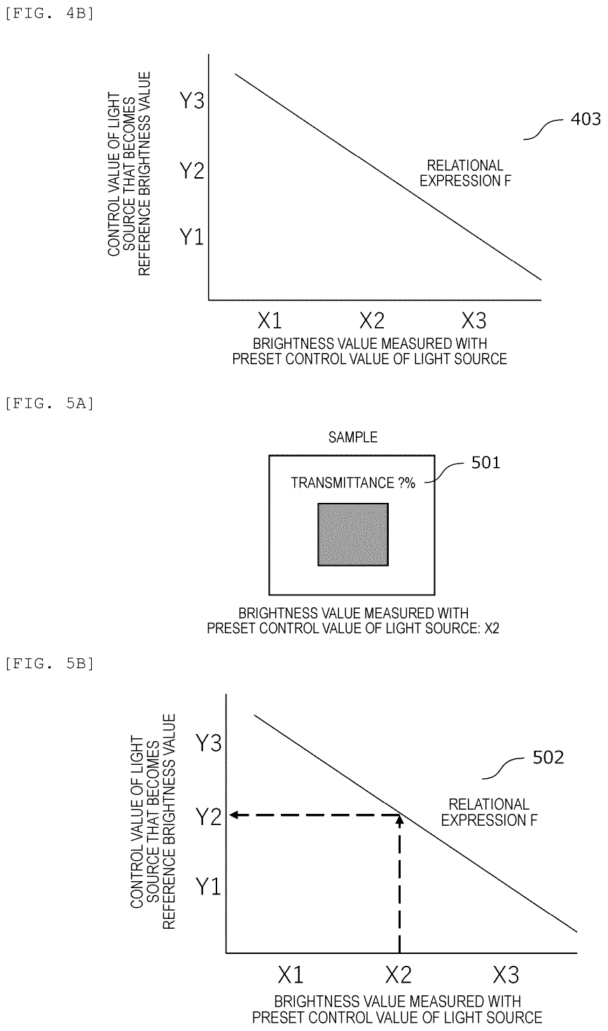

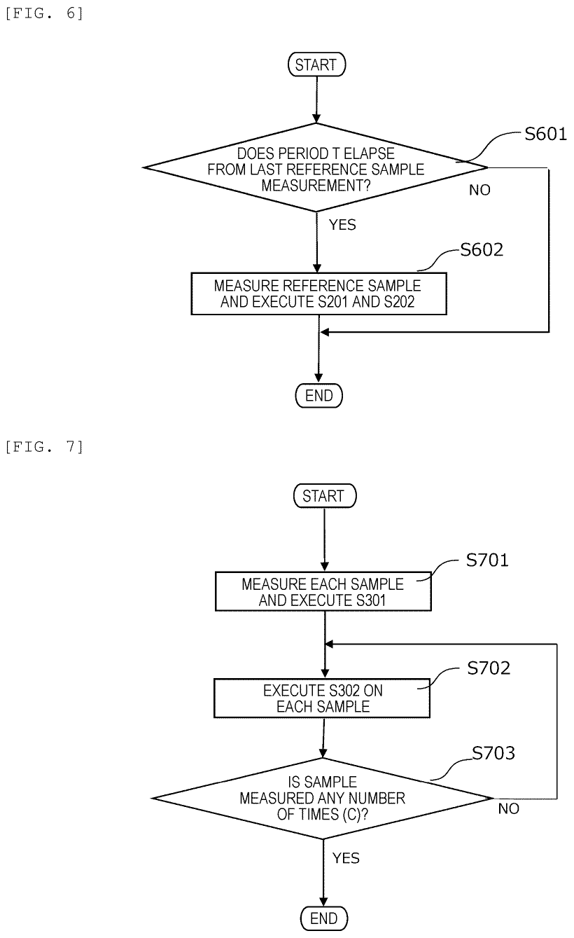

FIGS. 5A and 5B illustrate a relationship between the control values of the light source for the sample.

FIG. 5A illustrates an example in which a sample 501 is the sample 106 in which impurities are mixed. The light transmittance of impurities is unknown. Therefore, in step S302, the light transmittance of the impurities is estimated from the brightness value measured using the preset control value of the light source 101. An expression 502 illustrated in FIG. 5B represents a method of determining a value for controlling the light source 101 when measuring the sample 106 from the relational expression F obtained in step S202.

As described above, according to Embodiment 1, in the analysis method and the analysis device that irradiate the sample with light and acquire a measured value, the control value of the light source 101 is corrected so that the brightness value of the sample 106 containing impurities is constant. With this, an effect capable of suppressing fluctuations in the quantity of received light that varies due to impurities, improving the accuracy of image analysis, and improving the measurement accuracy can be obtained.

Further, by using the analysis method and the analysis device of Embodiment 1, the control value of the light source for correcting the quantity of irradiation light for each sample can be determined from the results obtained by performing measurement using the preset control value of the light source, and thus, there is no need to search for an appropriate control value of the light source, and the time required to correct the light source for each sample can be shortened.

According to Embodiment 1, a user does not need a process of reacting the sample with a reagent or removing impurities, and can shorten the time required for measurement. In addition, the reagent becomes unnecessary, which leads to cost reductions.

That is, according to Embodiment 1, it is possible to realize an analysis method and an analysis device that can exclude the influence of impurities during measurement and obtain the accurate brightness value of the object to be measured, while suppressing increases in cost and complication of work processes.

### Embodiment 2

Next, Embodiment 2 will be described.

In Embodiment 2, an analysis method and an analysis device for correcting and measuring the influence of impurities on a quantity of received light by a decrease in detection sensitivity due to fluctuations in the quantity of received light caused by impurities contained in a sample and deterioration of parts with lapse of time and the instrumental errors between devices, in the analysis method and the analysis device that irradiate the sample with light and acquire a measured value, will be described.

In Embodiment 2, a configuration of the analysis device that irradiates the sample with light and acquires the measured value is the same as that of Embodiment 1 (contents described in FIG. 1).

In Embodiment 1, the control value of the light source 101 when measuring the sample 106 is determined based on the brightness value acquired by irradiating the reference sample 108, whose light transmittance or color is known in advance, with the reference light quantity and the quantity of irradiation light from the light source 101 for obtaining the reference brightness value. With this, the analysis method and the analysis device for correcting fluctuations in the quantity of received light caused by impurities have been described.

In Embodiment 2, by repeatedly measuring the brightness value acquired when irradiating the reference sample 108 with the reference light quantity, and the quantity of irradiation light from the light source 101 for obtaining the reference brightness value at regular intervals in Embodiment 1, fluctuations in the quantity of received light caused by impurities, instrumental errors between devices, and deterioration of the components of the device with lapse of time are corrected.

FIG. 6 is a flowchart of measuring the reference sample in Embodiment 2, which is performed by the control unit 105.

In FIG. 6, in step S601, it is determined whether the reference sample 108 is to be measured. It is determined whether a period T, which is a period of time from last reference sample measurement (measurement for obtaining the relational expression F described in Embodiment 1), elapses. When the period T does not elapse from the last reference sample measurement, the process ends. When the period T does not elapse or the measurement is not performed at all, the process advances to step S602, the reference sample 108 is measured, and steps S201 and S202 illustrated in FIG. 2 are executed.

FIG. 7 is a flowchart of measuring the sample 106 to be measured in Embodiment 2, which is performed by the control unit 105.

In FIG. 7, in step S701, the sample 106 is measured, and step S301 illustrated in FIG. 3 is executed. Next, in step S702, step S302 illustrated in FIG. 3 is executed based on the reference sample 108 measured in step S602 illustrated in FIG. 6. Next, in step S703, it is determined whether the sample 106 is measured any number of times (C times).

The process of step S702 is executed repeatedly at regular intervals on each sample 106 and each sample 106 is measured using the same control value of the light source 101. For a sample that is measured any number of times (C times), the measurement is finished. In this case, step S702 may be executed on one sample 106, and while performing measurement repeatedly, the process of step S701 or step S702 may be executed on another sample 106.

Here, the fact that the sample 106 is to be repeatedly measured any number of times in step S703 is described.

In measurements where the detection unit that measures the quantity of received light is a two-dimensional sensor such as the camera 103, and the purpose is to capture the shape of an object appearing in an image, by correcting the control value of the light source using an average value of brightness detected by a plurality of elements, and the like as a reference brightness, and measuring the sample 106 once using the control value, it is possible to acquire an image in which the difference in average brightness (difference in contrast) of images occurring between the samples 106 is corrected.

With this, it becomes easy to set a brightness threshold value constant in binarization processing or the like when extracting an object in image analysis.

On the other hand, in measurements where the detection unit that measures the quantity of received light is a one-dimensional sensor such as a diode, and the purpose is to capture changes with lapse of time of the sample 106, by correcting the control value of the light source 101 so that the same brightness is obtained for the sample 106 and measuring the sample 106 twice or more using the control value, it is possible to correct the difference in brightness occurring between the samples 106 and capture changes in brightness with lapse of time.

Further, in measurements where the detection unit that measures the quantity of received light is a two-dimensional sensor such as the camera 103, and the purpose is to capture changes with lapse of time of an object (sample to be measured) that appears in the image, by correcting the control value of the light source 101 using the average value of brightness detected by a plurality of elements, and the like as a reference brightness, and measuring the sample twice or more using the control value, it is possible to acquire changes in brightness with lapse of time for an image in which the difference in average brightness (difference in contrast) of the images that occurs between the samples 106 is corrected.

That is, the control unit 105 can cause the storage unit 104 to store the adjustment control value of the light source 101 for each sample 106 to be measured and correct the light source 101 using the adjustment control value in measuring changes with lapse of time of the sample 106 to be measured, and perform the measurement.

For the above reasons, the sample 106 is repeatedly measured any number of times in step S703. The any number of times may be two or more times.

As described above, in Embodiment 2, the same effects as in Embodiment 1 can be obtained, and in addition, in the analysis method and the analysis device that irradiate the sample 106 with light and acquire a measured value, the control value of the light source 101 is corrected based on the measured value of the reference sample 108. Further, the reference sample 108 is repeatedly measured at regular intervals. With this, even when the quantity of received light fluctuates due to impurities contained in the sample 106, even if the quantity of irradiation light from the light source 101 decreases due to instrumental errors of the analysis device 100 or deterioration of parts with lapse of time, the effect of improving measurement accuracy can be obtained by changing the value for controlling the light source 101 during sample measurement. Furthermore, the lifespan of respective parts can be extended.

The embodiments described above are illustrative for describing the invention, and are not intended to limit the scope of the invention only to the embodiments.

### REFERENCE SIGNS LIST

100: analysis device
101: light source
102: objective lens
103: camera
104: storage unit
105: control unit
106: sample
107: sample container
108: reference sample
109: reference sample container
110: holding unit
111: accommodation unit

1. An analysis method of irradiating a sample with light and analyzing the sample by using a light source that irradiates the sample with light, an imaging unit that condenses transmitted light transmitting through the sample, receives a quantity of the condensed light, and acquires a brightness value, and a control unit that controls the light source and the imaging unit, the analysis method comprising:
irradiating two or more reference samples that differ in at least one of transmittance or color with light from the light source using a preset control value;
storing a relational expression between measured brightness values of the two or more reference sample acquired by the imaging unit and two or more adjustment control values of the light source for adjusting the measured brightness values of the two or more reference sample to a preset reference brightness value in a storage unit;
irradiating a sample to be measured with light from the light source using the preset control value;
calculating the adjustment control value of the light source, based on the relational expression stored in the storage unit, from a brightness value of the sample to be measured acquired by the imaging unit; and
performing irradiation with light from the light source using the calculated adjustment control value and acquiring the brightness value of the sample to be measured by the imaging unit.

2. The analysis method according to claim 1, wherein
the adjustment control value of the light source is stored in the storage unit for each sample to be measured, and in measuring a change with lapse of time of the sample to be measured, the adjustment control value is used to correct the light source and measurement is performed.

3. The analysis method according to claim 1, wherein
when a certain period of time elapses from last measurement of the reference sample,
the measurement of the reference sample is performed, and
the relational expression between the measured brightness value of two or more reference sample and the two or more adjustment control values of the light source for adjusting the measured brightness values of the two or more reference sample to the preset reference brightness value, is stored in the storage unit.

4. An analysis device that irradiates a sample with light, analyzes the sample, and includes a light source that irradiates the sample with light, an imaging unit that condenses transmitted light transmitting through the sample, receives a quantity of the condensed light, and acquires a brightness value, and a control unit that controls the light source and the imaging unit, the analysis device comprising:
two or more reference samples that differ in at least one of transmittance or color; and
a storage unit that stores the brightness value and a control value of the light source, wherein
the control unit
causes the reference sample to be irradiated with light from the light source using a preset control value and causes the storage unit to store a relational expression between measured brightness values of the two or more reference sample acquired by the imaging unit and two or more adjustment control values of the light source for adjusting the measured brightness values of the two or more reference sample to a preset reference brightness,
irradiates a sample to be measured with light from the light source using the preset control value and calculates the adjustment control value of the light source, based on the relational expression stored in the storage unit, from a brightness value of the sample to be measured acquired by the imaging unit, and
causes irradiation with light from the light source to be performed using the calculated adjustment control value and causes the imaging unit to acquire the brightness value of the sample to be measured.

5. The analysis device according to claim 4, wherein
the control unit causes the storage unit to store the adjustment control value of the light source for each sample to be measured, and corrects the light source using the adjustment control value in measuring a change with lapse of time of the sample to be measured, and performs measurement.

6. The analysis device according to claim 4, wherein
the control unit,
when a certain period of time elapses from last measurement of the reference sample,
causes the measurement of the reference sample to be performed, and
causes the storage unit to store the relational expression between the measured brightness values of the two or more reference samples and the two or more adjustment control values of the light source for adjusting the measured brightness values of the two or more reference sample to the preset reference brightness value.
